(19) United States
(12) Patent Application Publication
(10) Pub. No.: US 2019/0385255 A1
(43) Pub. Date: Dec. 19, 2019

(54) RESOURCES ALLOCATION TOOL FOR PARTIES IN A SEPARATION

(71) Applicant: Managed Divorce Pty. Ltd., Brisbane, Queensland (AU)

(72) Inventors: Andrew William Wight, Brisbane, Queensland (AU); Robert Zane Wight, Brisbane, Queensland (AU); William Francis James Wight, Brisbane, Queensland (AU)

(21) Appl. No.: 16/479,239

(22) PCT Filed: Jan. 12, 2018
(86) PCT No.: PCT/AU2018/050016

§ 371 Date: Jul. 19, 2019

(30) Foreign Application Priority Data
Jan. 20, 2017 (AU) 2017900177

(51) Int. Cl. G06Q 50/18; G06Q 10/06

(52) U.S. Cl. CPC G06Q 50/18; G06Q 10/0631

(57) ABSTRACT

A resource allocation tool and method are provided for allocating resources between parties in a separation. The resource allocation tool includes a processor, configured to determine a target distribution of the resources between the parties; and a graphical user interface, configured to enable the parties to interactively define a distribution of the resources between the parties. The processor is further configured to compare the interactively defined distribution of resources with the target distribution of resources, and provide feedback based thereon to enable the parties to iteratively define the distribution of the resources.

### TECHNICAL FIELD

The present invention relates to separation and divorce. In particular, although not exclusively, the present invention relates to methods and tools for managing the distribution of resources between the parties in a separation.

### BACKGROUND ART

Separation and divorce is often a very difficult and emotional time for all involved. One such aspect is the distribution of assets such as property, money and belongings between the parties.

In many cases, lawyers are engaged to handle negotiations regarding such distribution of assets, which is very costly. In particular, these negotiations are often undertaken in the form of lengthy demands and counter-demands, which may span over several months. In addition to the high cost of this approach, such negotiations are generally very slow.

Reaching an agreement directly between the parties thus offers advantages over lawyer-based negotiations, including reduced legal costs and more efficient negotiations. Furthermore, an agreement directly between the parties is likely to result in a better continued relationship, which is particularly important for parents.

However, a problem with reaching agreements directly between the parties is that doing so is often difficult, and the resulting agreement may not be fair. The distribution of resources among parties generally need not be equal, but instead fair, and take into account factors such as the future needs of each person, disparity in income, and the need for upskilling.

Another problem with reaching agreements directly between the parties is that the resulting agreement may not be feasible. In particular, when there is a strong desire to reach an agreement, one party may inadvertently agree to a distribution that is not feasible with respect to income and cost of living.

As such, there is clearly a need for improved methods and systems for allocating resources in a separation.

It will be clearly understood that, if a prior art publication is referred to herein, this reference does not constitute an admission that the publication forms part of the common general knowledge in the art in Australia or in any other country.

### SUMMARY OF INVENTION

The present invention is directed to resource allocation tools and methods, which may at least partially overcome at least one of the abovementioned disadvantages or provide the consumer with a useful or commercial choice.

With the foregoing in view, the present invention in one form, resides broadly in a resource allocation tool for allocating resources between parties in a separation, the tool including:

a processor, configured to determine a target distribution of the resources between the parties; and

a graphical user interface, configured to enable the parties to interactively define a distribution of each of the resources between the parties,

wherein the processor is further configured to compare the interactively defined distribution of resources with the target distribution of resources, and provide feedback based thereon to enable the parties to iteratively define the distribution of the resources.

Advantageously, the tool enables the parties to collaboratively distribute assets using interactive graphical representations thereof, and quickly iterate from a starting point to an option that they are both satisfied with using the feedback of the tool. By providing objective feedback from the tool, the parties are more likely to focus on solutions than direct anger and frustration towards each other. As a result, the tool may enable more efficient negotiations, and reduced legal costs, while providing an allocation which is fair.

Preferably, the resource allocation tool is configured to allocate resources between parties after the breakdown of a marriage. Alternatively or additionally, the resource allocation tool may be configured to allocate resources between parties after the breakdown of a de facto relationship.

Preferably, the target distribution of the resources is a proportionate distribution of resources.

Preferably, the feedback is provided as the resources are interactively mapped. Preferably, the feedback is provided at (or near) real time.

Preferably, the resources comprise one or more of an asset, a debt, an income and an expense.

Preferably, the graphical user interface includes interactive resource elements corresponding to each of at least a subset of the resources, and a plurality of distribution regions, wherein the distribution of the resources between the parties is defined by moving the interactive resource elements to a distribution region.

Preferably, the plurality of distribution regions include a first region, associated with a first party, a second region associated with the second party.

Preferably, the interactive resource elements are moved by direct manipulation of the interactive resource element onto the distribution region. Suitably, the resource elements are dragged and dropped onto the distribution region.

Preferably, the interactive resource elements may be defined as split resources, wherein the graphical user interface defines how the resource is to be split between the parties with reference to a third region associated with both the first party and the second party.

Preferably, the resource allocation tool and the graphical user interface are configured to be used collaboratively by the parties. Suitably, the graphical user interface may be configured to be used by both parties.

Preferably, the tool includes a touch screen, on which the graphical user interface is provided, with which the parties interact. The touch screen may comprise a touch screen television.

Preferably, the graphical user interface includes a bar graphically representing a proportionate distribution of resources between the parties. The bar may include a marker indicating the target distribution of the resources.

Preferably, the target distribution is determined according to an equal contribution, with one or more adjusters according to differences in circumstances between the parties. Suitably, the adjusters may be configured to adjust according to a difference in care of children, the need for upskilling, and the need for transition support of one of the parties. Similarly, the adjusters may be configured to adjust according to a difference in pre-relationship contribution, unequal contribution during the relationship, and consideration of superannuation.

Alternatively, the target distribution is determined according to probability data received according to analysis of a brief. The brief may be agreed by the parties, and provided to a plurality of lawyers for the analysis. The target distribution may comprise part of a probability density function generated according to the probability data of the plurality of lawyers.

Preferably, the resource allocation tool is configured to generate documents according to the interactively defined distribution of the resources. The documents may include documents for applying for consent orders in the Family Court.

Preferably, the resource allocation tool is configured to receive details of the resources. The details may include a value associated with the resource. The value may be positive (e.g. an asset resource) or negative (e.g. a debt).

The resources may include cash-flow resources.

Preferably, the resource allocation tool is configured to receive income details of parties, and determine the target distribution in part based thereon.

Preferably, the resource allocation tool is configured to receive care of children details of parties, and determine the target distribution in part based thereon.

Preferably, the resource allocation tool is configured to receive up-skilling or reskilling needs of one of the parties, and determine the target distribution in part based thereon.

Preferably, the resource allocation tool is configured to determine transition support needs of one of the parties, and determine the target distribution in part based thereon.

Preferably, the feedback is determined according to thresholds with reference to the target distribution. The thresholds may correspond to categories, including very fair, fair, marginally fair, unfair and grossly unfair.

Preferable, the processor is further configured to determine a feasibility of the interactively defined distribution of resources, and provide feedback based thereon to further enable the parties to iteratively define the distribution of the resources.

Preferably, the feasibility is determined by determining a cashflow of each of the parties based upon the interactively defined distribution of resources, and comparing the cashflow with a defined minimum cashflow.

The cashflow may be determined according to an income level of each of the parties.

The resources may include a delta asset, where the value for distribution is determined according to a difference between a value of the asset at the end of the relationship between the parties, and a value of the asset at the start of the relationship.

Preferably, the resource allocation tool includes a memory, configured to store details of a plurality of resources and details of the interactively defined distribution

In another form, the invention resides broadly in a resource allocation method for allocating resources between parties in a separation, the method including:

determining, by a processor, a target distribution of the resources between the parties;

providing a graphical user interface configured to enable the parties to interactively define a distribution of the resources between the parties; and

comparing, by the processor, the interactively defined distribution of resources with the target distribution of resources, and providing feedback based thereon to enable the parties to iteratively define the distribution of the resources.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates a separation and divorce system, according to an embodiment of the present invention;

FIG. 2 illustrates a screenshot of an exemplary basic data input screen of the system of FIG. 1, according to an embodiment of the present invention;

FIG. 3 illustrates a screenshot of an exemplary resource input screen of the system of FIG. 1, according to an embodiment of the present invention;

FIG. 4 illustrates a screenshot of an exemplary resource sub-type selection screen of the system of FIG. 1, according to an embodiment of the present invention;

FIG. 5 illustrates a screenshot of an exemplary property entry screen of the system of FIG. 1, according to an embodiment of the present invention;

FIG. 6 illustrates a screenshot of an exemplary resource overview and target distribution screen of the system of FIG. 1, according to an embodiment of the present invention.

FIG. 7 illustrates a first screenshot of an exemplary resource allocation screen of the system of FIG. 1, according to an embodiment of the present invention.

FIG. 8 illustrates a second screenshot of the resource allocation screen, illustrating the split of a resource.

FIG. 9 illustrates a third screenshot of the resource allocation screen, with a complete resource allocation and illustrating fairness and feasibility results, according to an embodiment of the present invention;

FIG. 10 illustrates a resource allocation details screen of the system of FIG. 1, including further details of the fairness and feasibility results, according to an embodiment of the present invention;

FIG. 11 illustrates a cash flow summary screen of the system of FIG. 1, according to an embodiment of the present invention;

FIG. 12 illustrates a screenshot of an advice input screen of the system, according to an embodiment of the present invention;

FIG. 13 illustrates a screenshot of a resource allocation screen, according to an embodiment of the present invention;

FIG. 14 illustrates a resource allocation method for allocating resources between parties in a separation, according to an embodiment of the present invention;

FIG. 15 illustrates a method of determining a target distribution of resources, according to an embodiment of the present invention; and

FIG. 16 illustrates an alternative method of determining a target distribution of resources, according to an embodiment of the present invention.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

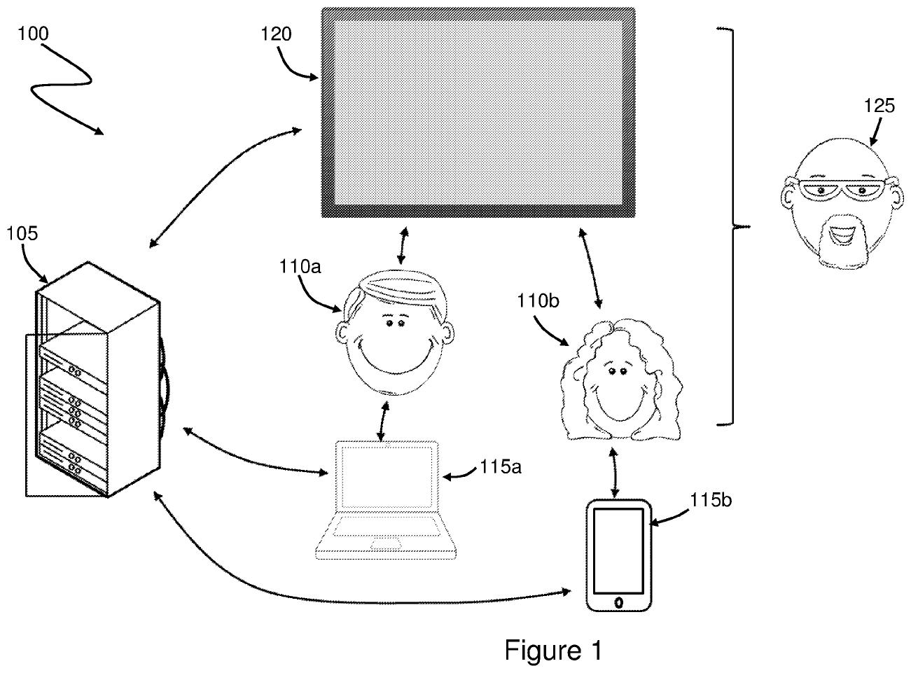

FIG. 1 illustrates a separation and divorce system 100, according to an embodiment of the present invention. The system 100 comprises a resource allocation tool for allocating resources between parties in a separation and enables separating couples to create fair and feasible settlements through collaboration, as outlined below.

The system 100 enables the parties to distribute assets using interactive graphical representations thereof, and get objective, real-time feedback on whether the distribution is fair and feasible. By providing real-time (or near real-time) feedback, the parties are able to quickly iterate from a starting point to an option that they are both satisfied with. Furthermore, by providing objective feedback, the parties are more likely to focus on solutions than direct anger and frustration towards each other.

The system 100 includes a server 105, with which both parties in the separation 110a, 110b initially interact using respective user devices 115a, 115b. In particular, basic data is entered in relation to each of the parties, such as age, income, income potential, whether re-skilling is needed, number of children and percentage of care for each of the children.

Each party 110a, 110b may enter data about him or herself, or data relating to the other party 110a, 110b. In some embodiments, the first party 110a may enter all basic data, which may be reviewed and approved by the second party 110b. In other embodiments, the parties 110a, 110b jointly enter the data.

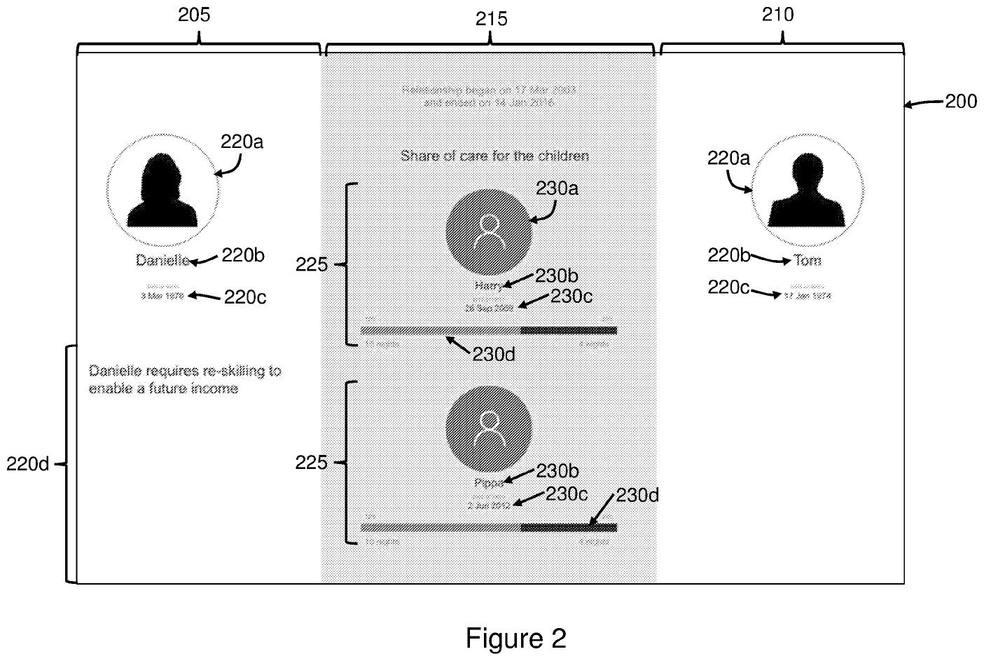

FIG. 2 illustrates a screenshot 200 of an exemplary basic data input screen of the system 100, according to an embodiment of the present invention.

The basic data input screen includes a first party section 205, a second party section 210 and a shared children section 215. Each of the first party section 205 and the second party section 210 includes details regarding the respective party 110a, 110b in the form of an image 220a, a name 220b, and a date of birth 220c. Each of the first party section 205 and the second party section 210 further include an additional information area 220d, which includes additional (e.g. optional) information about the associated party 110a, 110b.

By selecting the image 220a, the name 220b, the date of birth 220c, and/or the additional information area 220d, the user is able to enter corresponding details in relation to that party 110a, 110b. In particular, each item 220a-220d is initially filled with default data, and is selectable and editable.

The shared children section 215 includes a plurality of child elements 225, each including an image 230a, a name 230b, and a date of birth 230c, much like the first party section 205 and the second party section 210. The child elements 225 each include a care level drag bar 230d, which enables the parties 110a, 110b to define a level of shared care for the child.

The parties 110a, 110b may click on the shared children section 215 to add further children, so that there is a child element for each child under joint care. As such, the basic data input screen can be used to provide a comprehensive overview of the care of the children, which can then be used in part to define the distribution of resources, as described below.

The basic data input screen provides a simple, graphical overview of the basic data, which enables a user (which may be either or both of the parties 110a, 110b, for example), to quickly get an overview of the input data, identify errors or missing data, and update same accordingly.

Once the basic data has been input, the parties 110a, 110b then define resources, both positive (e.g. assets) and negative (e.g. debts), and cashflow resources. Examples of cash flow resources include salary, other income, accommodation costs, self-support costs, lifestyle costs, care of children costs, childcare costs, interest on loans, child support, previous child support, government assistance and taxation. Examples of asset resources include as real estate, motor vehicles, furniture, furnishing and effects, funds in financial institutions, interest in private business, investments, life insurance policies, other property, credit/charge cards, other loans, tax debts, promissory assets, superannuation, certain excluded assets, and delta assets.

A delta asset is an asset that was owned by one party prior to the relationship, and the value for distribution of the delta asset is determined according to a difference between a value of the asset at the end of the relationship, and a value of the asset at the start of the relationship.

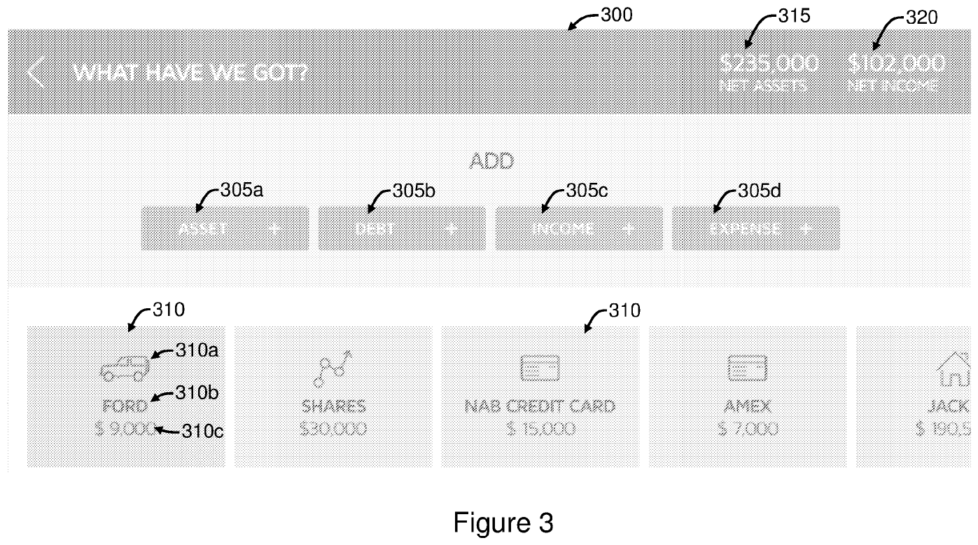

FIG. 3 illustrates a screenshot 300 of an exemplary resource input screen of the system 100, according to an embodiment of the present invention. The resource input screen may be used by one or both of the parties, much like the entry of the basic data discussed above.

The resource input screen includes a plurality of resource input buttons 305a-305d, for each of a plurality of resource types. In particular, the resource input buttons include an asset button 305a, a debt button 305b, an income button 305c, and an expense button 305d, for adding assets, debts, income and expenses, respectively.

The resource input screen further includes a plurality of resource elements 310, each including an image 310a, identifying a type of the resource, a name 310b, identifying a name of the resource, and a value 310c, indicating a value (or liability) associated with the resource. When a new asset is defined, it is included as a resource element 310.

The resource elements 310 enable the user to get a quick overview of the resources that have been added, which helps prevents resources from being inadvertently missed. This is particularly important when some resources are entered by one party and other resources are entered by the other party, or when many resources are added.

The resource input screen includes a net asset element 315, and a net income element 320, indicating a net value of the assets and income respectively. The net asset element 315 and the net income element 320 are updated automatically as resources are added, and are useful in providing an overview of the assets and income entered.

When a resource input button 305a-305d is selected, a resource sub-type selection screen is provided relating to the resource type of the selected resource input button 305a-305d. As an illustrative example, if the asset input button 305a is selected, the sub-types may relate to different asset sub-types, such as property, vehicles, shares and cash. Similarly, if the debt button 305b is selected, the sub-types types may relate to different debt sub-types, such as credit cards, personal loans, tax debt and student loans.

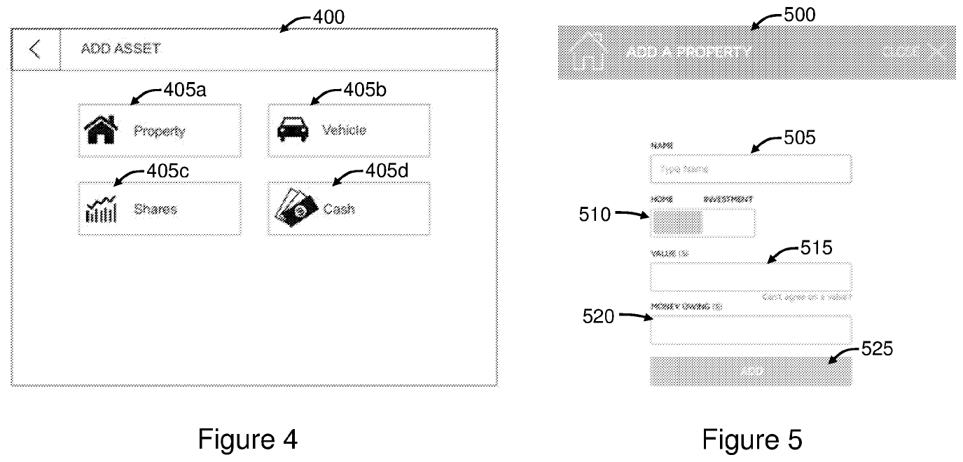

FIG. 4 illustrates a screenshot 400 of an exemplary resource sub-type selection screen of the system 100, according to an embodiment of the present invention. The exemplary resource sub-type selection screen relates to an asset sub-type.

The resource sub-type selection screen includes a plurality of sub-type selection buttons 405a-405d, namely a property selection button 405a, a vehicle selection button 405b, a shares selection button 405c, and a cash selection button 405d, for selecting property, vehicle, shares or cash sub-types, respectively.

Upon selection of a sub-type using the sub-type selection buttons 405a-405d, an add resource screen is provided relating to the selected resource sub-type. In particular, an add property screen is provided upon selection of the property selection button 405a, an add vehicle screen upon selection of the vehicle selection button 405b, an add shares screen upon selection of the shares selection button 405c, and an add cash screen upon selection of the cash selection button 405d.

FIG. 5 illustrates a screenshot 500 of an exemplary property entry screen of the system 100, according to an embodiment of the present invention.

The property entry screen includes a property name field 505, for entering a name of the property, a home/investment toggle button 510, for selecting whether the property is an investment property or a home, a value field 515, for entering a value of the property, and a money owing field 520, for entering an amount of money owing on the property.

Once the details are entered into the fields 505-520, an add button 525 may be selected, upon which the property is added as a new resource element 310 to the resource input screen. This process may be then repeated for all assets, debts, income and expenses.

In addition to the user entered resource details, the server 105 also calculates child support resource data based upon the basic data input earlier, and automatically associates child support costs (positive and negative) with each of the parties, which is particularly useful when calculating cashflow of the parties.

The skilled addressee will readily appreciate that the resource sub-type selection screen of FIG. 4 and the property entry screen of FIG. 5 may be easily modified to relate to other resources and resource sub-types.

Once all of the resource and basic data has been entered, the server 105 determines a target distribution of the resources between the parties 110a, 110b based thereon. In particular, an equal distribution is used as a starting point, with adjusters, e.g. based upon income disparity, unequal care of children and the need for up/re-skilling, to adjust the resource distribution. Additional or alternate adjusters may include adjusters based upon a difference in pre-relationship contribution, unequal contribution during the relationship, and consideration of superannuation.

The target distribution defines a proportional distribution of assets (e.g. 60/40, or $200,000/$175,000) between the parties, which is used to determine whether a proposed resource distribution is “fair” or not, as outlined below. In particular, as the parties define a distribution of resources, the server 105 compares the defined resource distribution to the target distribution, and indicates whether or not the resource distribution is fair or not (and to what extent) on a scale.

The system 100 further includes a touchscreen television 120, coupled to the server 105, which is used to enable collaborative allocation of resources between the parties 110a, 110b. In certain embodiments, the parties 110a-110b come together with a mediator 125, to collaboratively define the resource distribution on the touchscreen television 120 with the assistance of the mediator 125 when required.

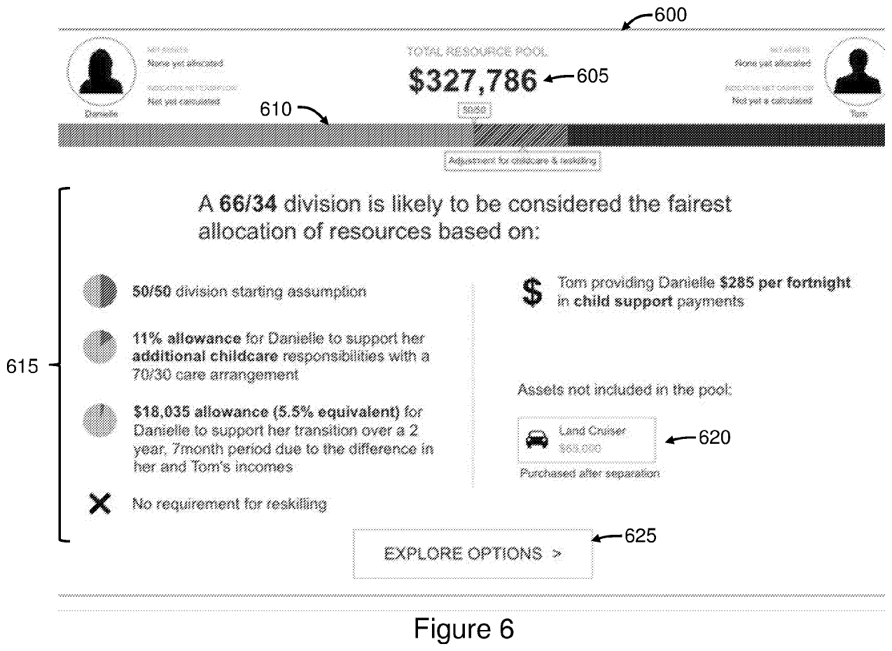

FIG. 6 illustrates a screenshot 600 of an exemplary resource overview screen, according to an embodiment of the present invention. The resource overview screen may be displayed on the touch screen television 120 to provide an overview of the resources for distribution, as well as the target resource distribution, prior to the collaborative allocation by the parties. As such, full transparency is provided between the parties, and the parties are presented with a common target immediately prior to the resource allocation.

The resource overview screen includes a total resource pool element 605, which is indicative of a total value of the resources to be allocated, a target distribution bar 610, indicative of a target distribution between the parties, and a distribution overview section 615, providing details of the target resource distribution, including factors contributing to the distribution.

The resource overview screen further includes one or more excluded resource elements 620, which relate to resources (e.g. assets) which are to be excluded from the distribution. Examples of such resources may include assets acquired after the separation, and are clearly indicated so to avoid any confusion among the parties 110a, 110b.

The target distribution bar 610 includes a 50/50 (equal) distribution reference, and an adjustment portion, to graphically illustrate an impact of the adjusters. This enables the users to not only identify a distribution between the parties, but also easily identify an impact of the adjusters.

The distribution overview section 615 including details of the distribution, including a percentage distribution (e.g. 66/34), as well as details of how the target distribution was determined (e.g. 50/50 starting assumption, additional childcare allowance, spousal maintenance and child support payments).

Once the parties have reviewed details of the resource overview screen, they may explore distribution options, and thus collaboratively define resource distributions, by selecting an explore options button 625, upon which a resource allocation screen is shown.

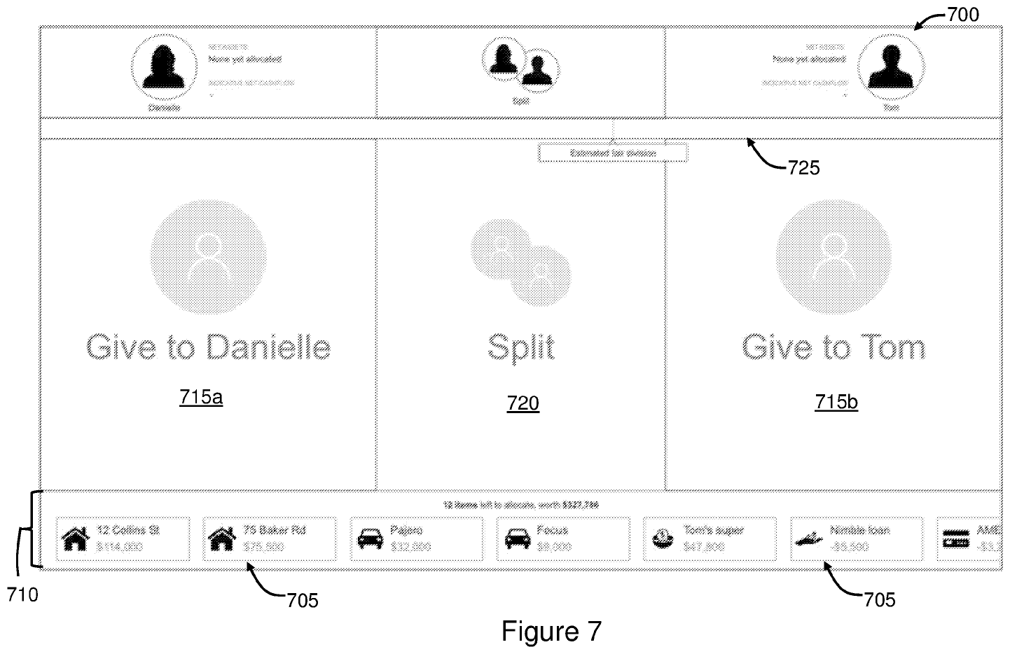

FIG. 7 illustrates a first screenshot 700 of an exemplary resource allocation screen, according to an embodiment of the present invention. Initially, no resources are allocated, and thus all resources are provided as resource elements 705 in an unallocated resource strip 710.

The parties may allocate resources to one of the parties, or to be split, by dragging a resource element 705 from the unallocated resource strip 710 to either a first party allocation area 715a, for allocation to the first party 110a, a second party allocation area 715b, for allocation to the second party 110b, or a split allocation area 720, for split allocation between the parties 110a, 110b.

As the one or more resources are allocated, a resource distribution bar 725 is updated to illustrate the proportionate distribution of resources between the parties. As an illustrative example, if the resources are distributed 50/50, the resource distribution bar 725 will graphically illustrate a distribution of 50/50 by graphically splitting the bar in half.

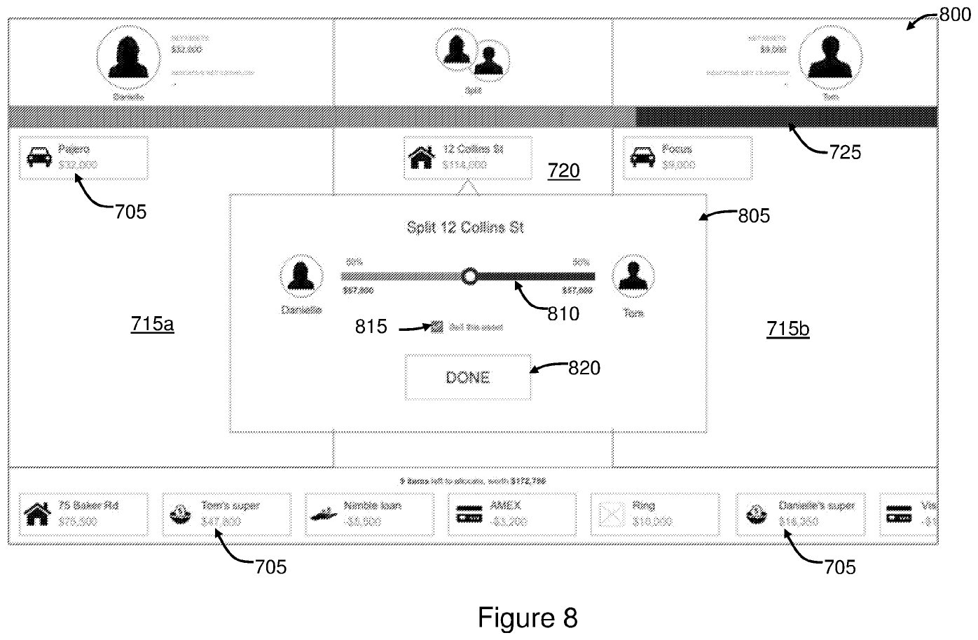

FIG. 8 illustrates a second screenshot of the resource allocation screen illustrating a partial distribution of resources, and the split of a resource. In particular, when a resource is dragged onto the split allocation area 720, a pop-up window 805 is provided that enables the user to define a split of the resource between the parties.

The pop-up window 805 includes a distribution split drag bar 810, which defines a split between the first party and the second party. As such, the user may drag the bar 810 to illustrate an unequal distribution of the resource.

The pop-up window 805 further includes a sell-asset checkbox 815, which enables the parties to decide whether the asset is to be sold or not. Finally, when ready, the parties may select a done button 820, upon which the resource element is placed into the split allocation area 720 with the defined distribution. The bar 725 is then updated according to the defined distribution.

Once all of the resources have been allocated, the resource allocation screen automatically determines a fairness of the allocation and displays same.

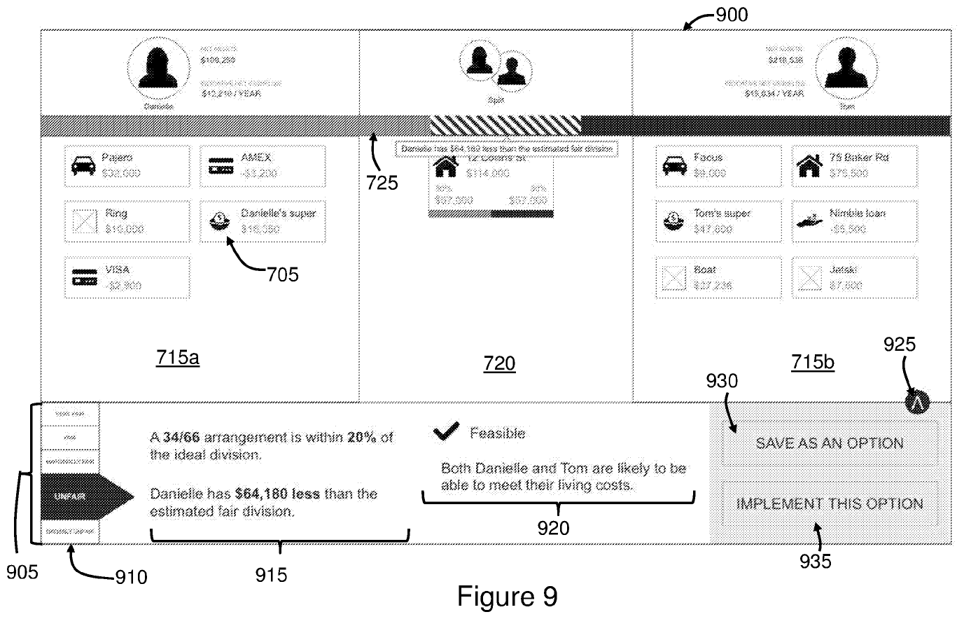

FIG. 9 illustrates a third screenshot 900 of the resource allocation screen, with a complete resource allocation and fairness overview, according to an embodiment of the present invention.

The resource strip 710 has been replaced by a fairness overview section 905. The fairness overview section 905 provides an overview of how fair (or unfair) the resource distribution is, based upon how far from the target resource distribution the interactively defined distribution is, and whether the distribution appears to be financially feasible.

The fairness overview section 905 includes a fairness scale 910, which includes elements forming a scale of very fair, fair, marginally fair, unfair and grossly unfair. An actual level of fairness is determined according to a difference between the target and the proposed distribution, and is highlighted on the fairness scale 910, e.g. by enlarging the associated element and/or changing a colour thereof.

A summary portion 915 of the fairness overview section 905 includes a written summary of the proposed distribution, including a relative difference between the proposed and actual distribution (e.g. within 20%) and an absolute difference between the proposed and actual distribution (e.g. $64,180).

The fairness overview section 905 also includes a feasibility indicator 920, which indicates whether the proposed distribution is feasible. This is particularly useful in ensuring that resources are not split in a manner where one party is unable to afford to maintain the distribution (e.g. costs or payments associated with a house).

The feasibility indicator 920 is set by determining a net cashflow of each of the parties, and comparing the net cashflow to a minimum cashflow threshold. If the net cashflow of one of the parties is below the minimum cashflow threshold, the distribution is not considered feasible.

The net cashflow of each of the parties is determined according to government assistance (e.g. parenting payment, newstart allowance, austudy, etc), cash flow input variables (e.g. accommodation, lifestyle costs, credit card interest, etc), fixed cashflow items associated with each of the parties, self-support costs which are adjusted according to income based upon Australian Bureau of Statistics data, and cashflow associated with the distribution of resources. In some embodiments, net cashflow elements may be determined according to a predefined formula or rule. As an illustrative example, the government assistance cashflow variables may be determined according to government formulae.

The fairness overview section 905 includes an expand button 925, which enables the parties to get further details on the proposed distribution, and save and implement option buttons 930, 935, to enable the user to save or implement an option respectively. In particular, the parties may save an option (i.e. a particular distribution of resources) for later use in case they are unsure if they are able to generate a better option, and may implement an option when they are both happy with it. Furthermore, the parties may save multiple alternatives for later consideration and to allow both parties to present alternative points of view.

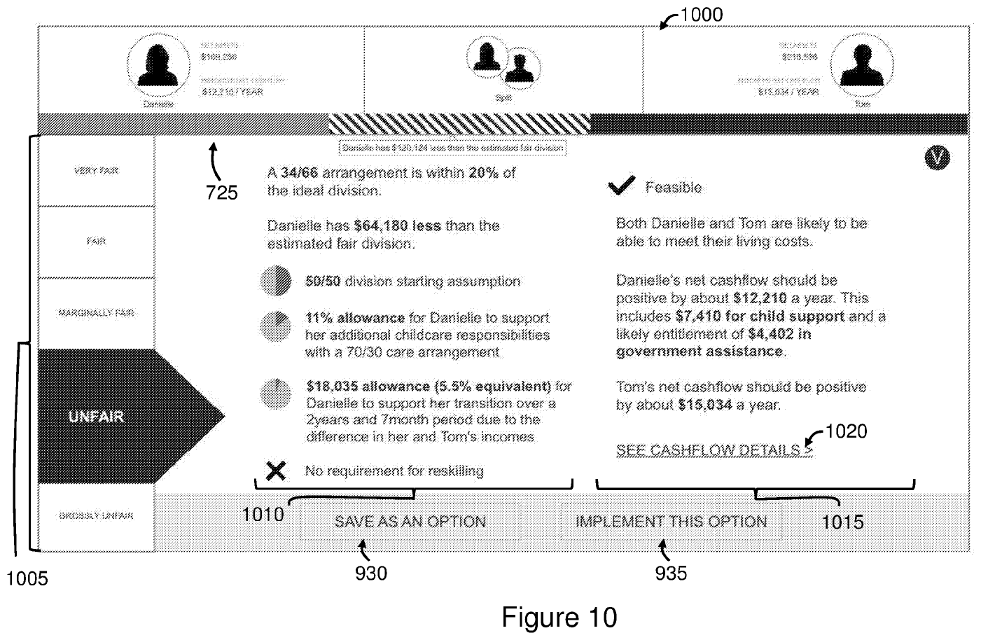

FIG. 10 illustrates a screenshot 1000 of a resource allocation details screen, according to an embodiment of the present invention. The resource allocation screen includes a fairness overview section 1005, similar to the fairness overview section 905, but with further detail. The further detail includes a target distribution section 1010, which includes details of the target distribution and details of the adjusters, much like the data from the distribution overview section 615 of FIG. 6, as well as a cashflow section 1015, which includes an overview of cashflow in association with the distribution and a feasibility indicator.

Further cash flow details can be obtained by selecting a cash flow details button 1020, as outlined below.

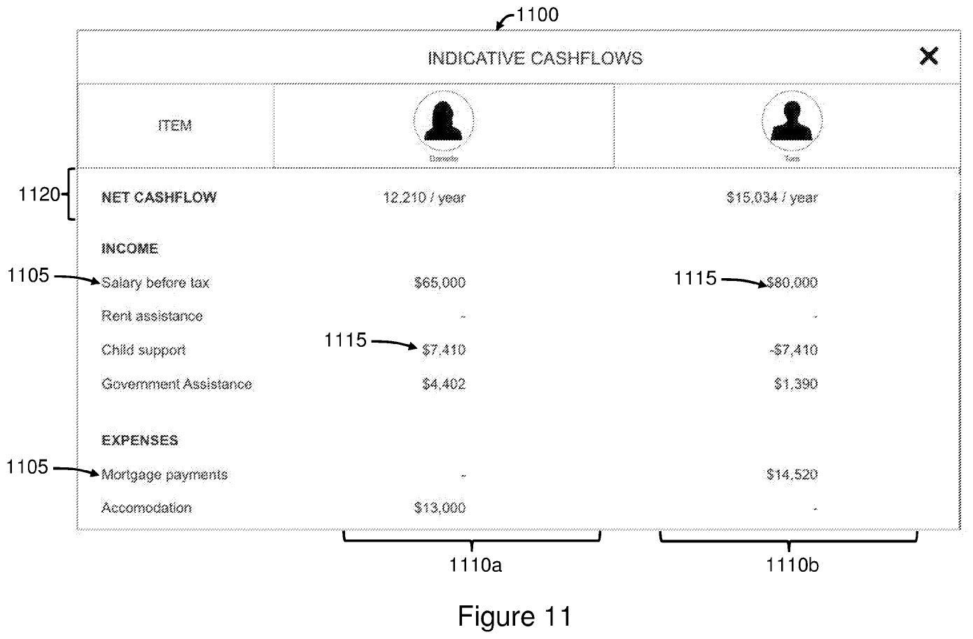

FIG. 11 illustrates a screenshot 1100 of a cash flow summary screen of the system 100, according to an embodiment of the present invention.

The cash flow screen includes a plurality of cash flow rows 1105, such as salary, child support, mortgage payments and the like, and a first and second party columns 1110a, 1110b, relating to the first and second parties 110a, 110b.

Cash flow elements 1115 are then associated with the cash flow rows 1105 and the first and second party columns 1110a, 1110b to provide an overview of the cash flow for each of the parties 110a, 110b. As such, the parties may review the cash flow data for each of the parties, and identify any potential problems, and reallocate resources based thereon.

Finally, the cash flow screen includes a net cashflow row 1120, illustrating a net cashflow for each of the parties 110a, 110b. This enables the parties to quickly identify general cash flow data relating to each of the parties.

According to alternative embodiments, the target distribution is determined according to input from one or more lawyers based upon a brief that is agreed upon between the parties. Furthermore, instead of identifying distributions as fair (or not), as outlined above, the one or more lawyers may provide advice regarding what are probable outcomes should the matter go to court, enabling a likelihood of the percentage split relating to the distribution being ordered by the court to be provided.

In particular, the brief consists of agreed facts as well as views on the needs and contributions of the parties. The views on the needs and contributions of the parties are not necessarily agreed by both of the parties, but are shared transparently and commented on by both parties.

The brief is then provided to each of the one or more lawyers for their respective advice. Each of the one or more lawyers then provides their advice in the form of three key inputs—1) party A's best case outcome; 2) party B's best case outcome; and 3) the most likely outcome if the matter were to go to court.

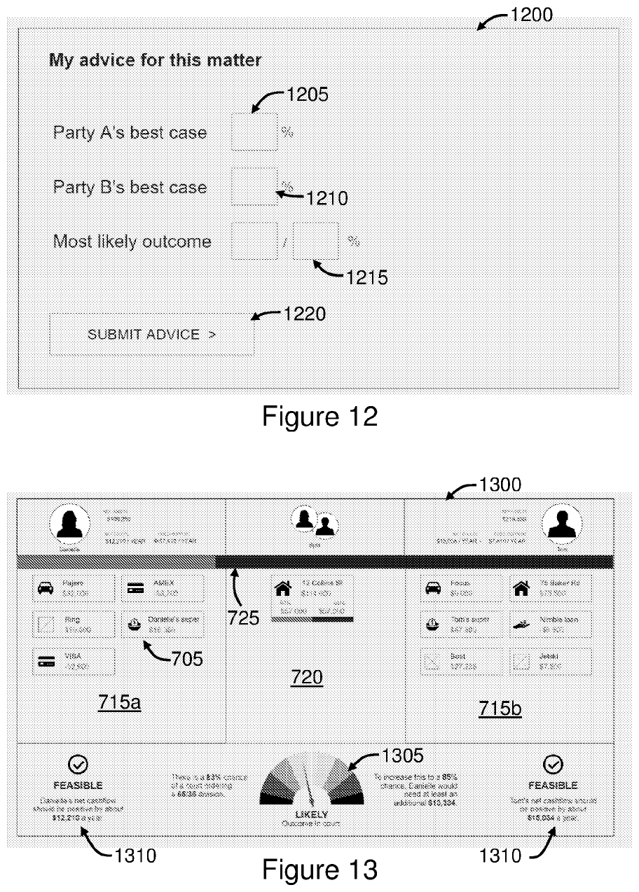

FIG. 12 illustrates a screenshot 1200 of an advice input screen of the system, according to an embodiment of the present invention. The advice input screen enables the one or more lawyers to provide their respective advice remotely, e.g. through the Internet.

The advice input screen includes a party A best case field 1205, a party B best case field 1210, and most likely outcome fields 1215, enabling the lawyer to enter best case information for each of the parties and a likely outcome. The best cases and likely outcome are in the form of a property distribution (e.g. %) between the parties, and relate to what the lawyer sees as being best case and likely outcomes should the matter be decided in court.

A probability density function is then created according to the input of each of the one or more lawyers. In particular, a function is first chosen to fit the distribution (e.g. a Gaussian function), and parameters are then chosen to fit the most likely outcome and the two best case outcomes (e.g. mean and standard deviation). The probability density function is then created based upon the function and parameters.

When more than one lawyer is used, the respective probability density functions are combined using weighted averaging to generated a coalesced probability density function. It is then determined whether there is consensus among the lawyers, and if not, input from other lawyers may be added, and/or outliers may be removed.

The skilled addressee will readily appreciate that consensus need not mean that all lawyers provide exactly the same advice, but instead that the advice is similar according to one or more metrics. As an illustrative example, the system may include analysis of previous opinions to determine what is considered “normal” deviation, and determine whether the deviation among lawyers is within such normal boundaries. Such process may, for example, utilise artificial intelligence or machine learning algorithms.

Similarly, the consensus may be determined by performing clustering on the lawyers' advice and determine whether the cluster is dense enough to give confidence of consensus. As an illustrative example, classification of advice may be performed using strict partitioning clustering with outliers, such as K-means clustering (centroid clustering) or a density-based clustering method such as Density-based spatial clustering of applications with noise (DBSCAN).

Once consensus is reached, the coalesced probability density function is used to provide feedback to the parties for a proposed distribution, much like the feedback described above, but in terms of probability. This may, for example, be performed by determining limits of integration for centric 95% probability on the coalesced probability density function, determining a width of integration for the centric 95% probability, and integrating the coalesced probability density function over a moving fixed width interval corresponding to the determined width of integration for the centric 95% probability. The integral corresponding to the proposed distribution is then provided as feedback corresponding to the probability of a court ordering such distribution.

FIG. 13 illustrates a screenshot of a resource allocation screen, according to an embodiment of the present invention. The resource allocation screen is similar to the resource allocations screen of FIGS. 7, 8 and 9, but incorporates probability based feedback according to the lawyers' advice, as outlined above.

The resource allocation screen includes the allocation areas 715a, 715b and 720, much like the earlier resource allocations screens, with feedback provided thereunder in the form of a probability gauge 1305. The probability gauge 1305 graphically provides feedback to the parties regarding whether the distribution identified thereabove is a likely outcome should the matter go to court, and thus enables the parties to choose a distribution that corresponds to an outcome that is likely. As such, and in contrast to the feedback described earlier, the resource allocation screen of FIG. 13 provides feedback in terms of likelihood rather than fairness.

The probability gauge 1305 is advantageously split into 9 segments of about 20 degrees each, and thus forming a half-circle. The 9 segments may correspond to highly likely (in the centre) and likely, marginally likely, unlikely, and highly unlikely on each side thereof. An arrow is then used to indicate where on the gauge the distribution lies.

According to certain embodiments, suggestions are provided in relation to the resource allocation screen to guide parties towards a more probable probability band, e.g. by indicating how far off the distribution is from that band.

The resource allocation screen further includes feasibility indicators 1310 for indicating whether the proposed distribution is feasible. The feasibility indicators 1310 are each associated with one of the parties, and indicate whether the resource allocation is feasible for that party based upon cashflow.

As the parties redistribute resources (e.g. by dragging and dropping, as outlined above), the probability gauge 1305 is automatically updated accordingly, providing real time information to the parties regarding the distributions.

While the above embodiment describes advice being received from lawyers regarding best cases and likely outcomes, the skilled addressee will readily appreciate that the advice need not be received from qualified lawyers. As an illustrative example, non-lawyers may provide such input based upon earlier matters that have been in court (or through comparison with example scenarios). Similarly, in some embodiments, artificial intelligence (AI) based systems may be used to generate likely outcomes based upon historical data.

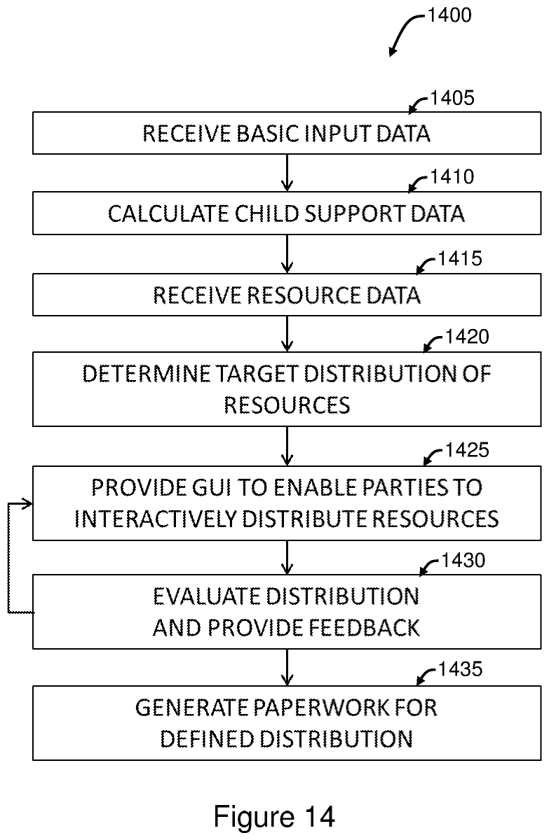

FIG. 14 illustrates a resource allocation method 1400 for allocating resources between parties in a separation, according to an embodiment of the present invention. The system 100 may implement the method 1400, or a variation thereof.

At step 1405, basic data is received from the parties. As an illustrative example, the basic data may be received using the basic data input screen of FIG. 2.

At step 1410, child support data is calculated based upon the input data. The child support data comprises child support amounts that are calculated as is done in human services, or the relevant government authority. By calculating child support here, and using the child support data in an agreement, rather than relying on a government order, collaboration and cooperation between the parties is supported.

At step 1415, resource data is received from the parties. As an illustrative example, the resource data may be received using the resource input screens of FIGS. 3-5, and may relate to positive and negative resources, as well as cash flow resources.

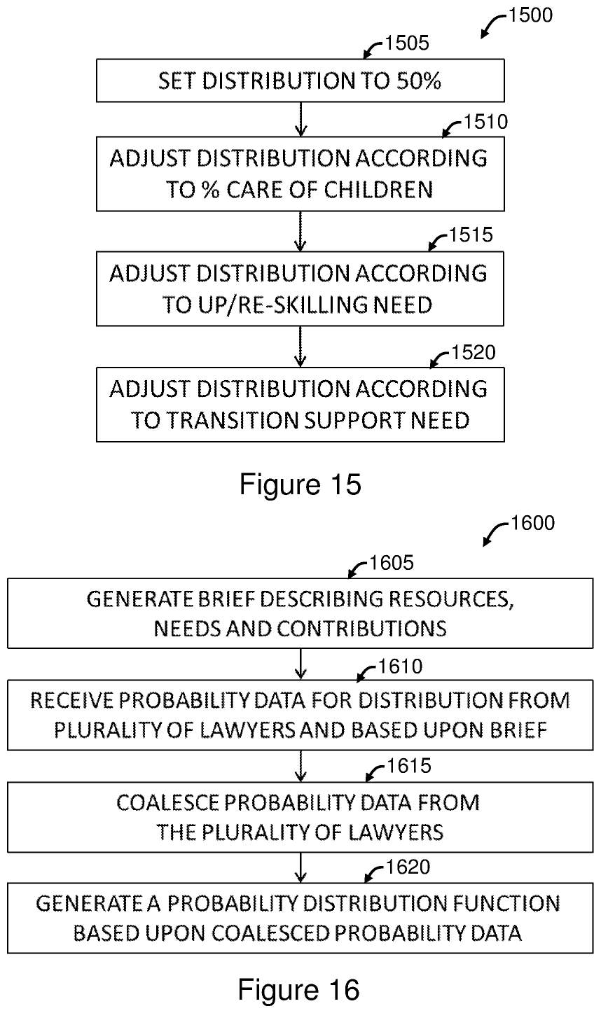

At step 1420, a target distribution of resources is determined. The target distribution of resources is proportionate (e.g. 60/40). FIGS. 15 and 16 below illustrate methods of determining a target distribution of resources that may be used in step 1420.

At step 1425, a graphical user interface is provided to the parties to enable the parties to interactively distribute the resources. As an illustrative example, the graphical user interface may be in the form of the resource allocation screen of FIGS. 7-9, and each resource may be allocated to one party, the other party, or split by dragging and dropping each resource into distribution regions or areas.

At step 1430, the distribution of resources defined by the parties is evaluated, and feedback is provided based thereon. In particular, the distribution of resources is compared to the target distribution of resources, and feedback is provided in relation to whether the distribution is fair or not, and to what level.

Advantageously, the feedback is provided immediately (or nearly immediately) after distribution of the resources, to enable efficient iteration between different definitions. As such, steps 1425 and 1430 may be repeated as many times as desired.

Once the parties are satisfied with the distribution of resources, paperwork may be generated in step 1435 accordingly. The paperwork may include a mediation agreement, summarising the agreed distribution, and documents for submission to a court for consent orders. The parties may then sign and submit the documents to a court for consent orders.

As discussed above, a mediator 125 may facilitate the conversation between the parties, particularly in relation to steps 1425 and 1430. This is particularly useful in case a discussion between the parties goes off target, or if there are difficulties in communication between the parties.

FIG. 15 illustrates a method 1500 of determining a target distribution of resources, according to an embodiment of the present invention. The method 1500 may be similar or identical to step 1420 of the method 1400.

At step 1505, the target distribution of resources is initialised to 50% each, i.e. equal distribution.

At step 1510, the target distribution of resources is adjusted according to a level of care of children provided by each of the parties. In particular, the distribution of resources is weighted towards a party with higher level of care of children. If there are no children, or care is equal, no adjustment is made in step 1510.

At step 1515, the target distribution of resources is adjusted according to a need for up-skilling or re-skilling by one of the parties. The level of adjustment due to the need for up-skilling or re-skilling is determined, and distribution is weighted towards a party with a need for up-skilling or re-skilling. If there is no need for up-skilling or re-skilling, no adjustment is made in step 1515.

At step 1520, the target distribution of resources is adjusted according to a need for transition support by one of the parties. The transition support is used to assist the lower income party in transitioning from a shared large income to a post-separation income where there is a large disparity between the parties. The purpose of the transition support is to provide spousal maintenance for a normalising time.

The normalising time is calculated according to a length of the relationship. In case the length of the relationship is less than 5 years, a normalising time of 0 is used, if the length of the relationship is greater than 25 years, a normalising time of 5 years is used, and therebetween a sliding scale is used between 0 and 5 years.

If there is no need for transition support, no adjustment is made in step 1520.

The skilled addressee will readily appreciate that other adjusters may be used to adjust the target distribution of resources to ensure that a “fair” distribution of resources is provided.

FIG. 16 illustrates a method 1600 of determining a target distribution of resources, in the form of probability distributions, according to an embodiment of the present invention. The method 1600 may be similar or identical to step 1420 of the method 1400.

At step 1605, a brief is generated describing the resources, needs and contributions of the parties. The brief is agreed by the parties for the purpose of generating the target distribution, and thus may be generated collaboratively between the parties.

Once completed and agreed, the brief is provided to a plurality of lawyers for review. This may be performed automatically using the system, and such that the lawyers remain anonymous.

At step 1610, probability data is received from each of the lawyers, the probability data relating to a distribution of resources. The probability data is in the form of three key inputs—1) party A's best case outcome; 2) party B's best case outcome; and 3) the most likely outcome if the matter were to go to court.

At step 1615, the probability data from each of the lawyers is coalesced. This may include removing outliers, or gaining further lawyer input should there not be substantial consensus among the lawyers.

At step 1620, a probability density function is generated based upon the coalesced probability data. The probability density function enables probabilities of different distributions to be readily determined, the most probable distribution corresponding to the target distribution.

Advantageously, the methods and systems described above enable the parties to collaboratively distribute assets using interactive graphical representations thereof, and quickly iterate from a starting point to an option that they are both satisfied with using the feedback. By providing objective feedback, the parties are more likely to focus on solutions than direct anger and frustration towards each other.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A resource allocation tool for allocating resources between parties in a separation, the tool including:
a processor, configured to determine a target distribution of the resources between the parties; and
a graphical user interface, configured to enable the parties to interactively define a distribution of the resources between the parties,
wherein the processor is further configured to compare the interactively defined distribution of resources with the target distribution of resources, and provide feedback based thereon to enable the parties to iteratively define the distribution of the resources.

2. The resource allocation tool of claim 1, configured to allocate resources between parties after the breakdown of a marriage or a de facto relationship.

3. (canceled)

4. The resource allocation tool of claim 1, wherein the feedback is provided as the resources are interactively mapped.

5. The resource allocation tool of claim 1, wherein the resources comprise one or more of an asset, a debt, an income and an expense.

6. The resource allocation tool of claim 1, wherein the graphical user interface includes interactive resource elements corresponding to each of at least a subset of the resources, and a plurality of distribution regions, wherein the distribution of the resources between the parties is defined by moving the interactive resource elements to a distribution region.

7. The resource allocation tool of claim 6, wherein the plurality of distribution regions include a first region, associated with a first party, a second region associated with the second party and wherein the interactive resource elements are moved by direct manipulation of the interactive resource element onto the distribution region.

8. (canceled)

9. (canceled)

10. The resource allocation tool of claim 6, wherein the interactive resource elements may be defined as split resources, wherein the graphical user interface defines how the resource is to be split between the parties with reference to a third region associated with both the first party and the second party.

11. The resource allocation tool of claim 1, wherein the resource allocation tool and the graphical user interface are configured to be used collaboratively by both parties and wherein the tool includes a touch screen, on which the graphical user interface is provided and with which the parties interact.

12. (canceled)

13. The resource allocation tool of claim 1, wherein the graphical user interface includes a bar graphically representing a proportionate distribution of resources between the parties and wherein the bar includes a marker indicating the target distribution of the resources.

14. (canceled)

15. The resource allocation tool of claim 1, wherein the target distribution is determined according to an equal contribution, with one or more adjusters according to differences in circumstances between the parties.

16. The resource allocation tool of claim 15, wherein the adjusters are configured to adjust according to at least one of a difference in care of children, the need for upskilling, the need for transition support of one of the parties, a difference in pre-relationship contribution, unequal contribution during the relationship, and consideration of superannuation.

17. The resource allocation tool of claim 1, wherein the resource allocation tool is configured to generate documents according to the interactively defined distribution of the resources, the documents including one or more documents for applying for consent orders in a Family Court.

18. The resource allocation tool of claim 1, wherein the resource allocation tool is configured to receive details of the resources, the details including a value associated with the resource.

19. The resource allocation tool of claim 1, wherein the resources include cash-flow resources.

20. The resource allocation tool of claim 1, wherein the resource allocation tool is configured to receive at least one of income details and care of children details of the parties, and determine the target distribution in part based thereon.

21. The resource allocation tool of claim 1, wherein the resource allocation tool is configured to receive care of children details of parties, and determine the target distribution in part based thereon.

22. (canceled)

23. The resource allocation tool of claim 1, wherein the resource allocation tool is configured to receive up-skilling or reskilling needs of one of the parties, or to determine transition support needs of one of the parties, and determine the target distribution in part based thereon.

24. (canceled)

25. (canceled)

26. The resource allocation tool of claim 1, wherein the processor is further configured to determine a feasibility of the interactively defined distribution of resources, and provide feedback based thereon to further enable the parties to iteratively define the distribution of the resources and wherein the feasibility is determined by determining a cashflow of each of the parties based upon the interactively defined distribution of resources, and comparing the cashflow with a defined minimum cashflow.

27. (canceled)

28. (canceled)

29. The resource allocation tool of claim 1, wherein the resources include a delta asset, where the value for distribution is determined according to a difference between a value of the asset at the end of the relationship between the parties, and a value of the asset at the start of the relationship.

30. (canceled)

31. A resource allocation method for allocating resources between parties in a separation, the method including:
determining, by a processor, a target distribution of the resources between the parties; providing a graphical user interface configured to enable the parties to interactively define a distribution of the resources between the parties; and
comparing, by the processor, the interactively defined distribution of resources with the target distribution of resources, and providing feedback based thereon to enable the parties to iteratively define the distribution of the resource
